(19) United States
(12) Patent Application Publication
(10) Pub. No.: US 2024/0137599 A1
(43) Pub. Date: Apr. 25, 2024

(54) TERMINAL AND NON-TRANSITORY COMPUTER-READABLE MEDIUM

(71) Applicant: 17LIVE Japan Inc., Tokyo (JP)

(72) Inventors: Yu-Cheng FAN, Taipei City (TW); Sz-Chi HUANG, Taipei City (TW); Chih-Yuan WANG, Taipei City (TW)

(21) Appl. No.: 18/346,590

(22) Filed: Jul. 2, 2023

(30) Foreign Application Priority Data
Oct. 20, 2022 (JP) 2022-168779

(51) Int. Cl. H04N 21/431; H04N 21/2187; H04N 21/4788

(52) U.S. Cl. CPC H04N 21/4312; H04N 21/2187; H04N 21/4788

(57) ABSTRACT

A terminal, comprising one or a plurality of processors, wherein the one or plurality of processors execute a machine-readable instruction to perform: receiving an object in a live streaming; displaying the object on the terminal; detecting a keyword in the object corresponding to a function in the live streaming; and triggering the function in response to an operation on the object. The present disclosure may allow the streamers to generate or amend an object such as stickers on the live streaming room in a more flexible manner. At the same time, the viewer may perform an operation on the object to realize a corresponding function in a more convenient manner. Therefore, the interaction among streamers and viewers may be increased, and the user experience may also be enhanced.

### CROSS-REFERENCE TO RELATED APPLICATIONS

This application is based on and claims the benefit of priority from Japanese Patent Application Serial No. 2022-168779 (filed on Oct. 21, 2022), the contents of which are hereby incorporated by reference in its entirety.

### TECHNICAL FIELD

This disclosure relates to information and communication technology, and in particular, to a terminal and a computer program for handling interaction data for a live streaming.

### BACKGROUND

Some APPs or platforms provide live streaming service for streamers and viewers to interact with each other. The streamers may have a performance to cheer up the viewer and the viewer may send gifts to support the streamers.

The APP or platform provider may allow the streamers to add additional objects such as stickers in their live streaming in order to decorate the streaming room or show some information for the viewers (For example, see Non-Patent Document 1). Moreover, Patent Document 2 disclose decorative stickers in the live broadcast interface of the viewer in order to improve the interaction between the streamer and viewer. The viewer may click the sticker to follow the streamers.

However, the sticker is corresponding to each viewer respectively and based on specific missions between the viewer and streamer. There may be more possibilities on the usage of the stickers and it may lead to better user experience for the streamers and viewers. Therefore, how to improve the usage of stickers is very important.
[Non-Patent Document 1]: 17LIVE: https://youtu.be/8hLPQ7lo5l?t=216
[Patent Document 2]: CN112969087A

### SUMMARY

An embodiment of subject application relates to a terminal, comprising one or a plurality of processors, wherein the one or plurality of processors execute a machine-readable instruction to perform: receiving an object in a live streaming; displaying the object on the terminal; detecting a keyword in the object corresponding to a function in the live streaming; and triggering the function in response to an operation on the object.

Another embodiment of subject application relates to a terminal, comprising one or a plurality of processors, wherein the one or plurality of processors execute a machine-readable instruction to perform: generating an object in a live streaming; and displaying the object on the terminal; wherein the object includes a keyword corresponding to a function in the live streaming.

Another embodiment of subject application relates to a non-transitory computer-readable medium including program instructions, that when executed by one or more processors, cause the one or more processors to execute: receiving an object in a live streaming; displaying the object on the terminal; detecting a keyword in the object corresponding to a function in the live streaming; and triggering the function in response to an operation on the object.

The present disclosure may allow the streamers to generate and amend an object such as stickers on the live streaming room in a more flexible manner. At the same time, the viewer may perform an operation on the object to realize a corresponding function in a more convenient manner. Therefore, the interaction among streamers and viewers may be increased, and the user experience may also be enhanced.

### BRIEF DESCRIPTION OF THE DRAWINGS

FIG. 1 is a schematic configuration of a live streaming system 1 according to some embodiments of subject application;

FIG. 2 is a schematic block diagram of the user terminal 20 according to some embodiments of subject application;

FIG. 3 is a schematic block diagram of the server 10 according to some embodiments of subject application;

FIG. 4 shows an exemplary data structure of the stream DB 320 of FIG. 3;

FIG. 5 shows an exemplary data structure of the user DB 322 of FIG. 3;

FIG. 6 shows an exemplary data structure of the gift DB 324 of FIG. 3;

FIG. 7 shows an exemplary data structure of the event DB 326 of FIG. 3;

FIG. 8 shows an exemplary data structure of the keyword look-up table 210 of FIG. 2;

FIG. 9—FIG. 18 are exemplary screen images of a live streaming room screen 600 shown on the display of the streamer user terminal 20 or the viewer user terminal 30;

FIG. 19 is a flowchart showing steps of an application activation process on the user terminals 20 and 30.

FIG. 20 is an exemplary sequence chart illustrating an operation of the configuration of the live streaming system 1 according to some embodiments of subject application.

FIG. 21 is an exemplary hardware configuration of the information processing device according to some embodiments of subject application.

### DETAILED DESCRIPTION

Hereinafter, the identical or similar components, members, procedures or signals shown in each drawing are referred to with like numerals in all the drawings, and thereby an overlapping description is appropriately omitted. Additionally, a portion of a member which is not important in the explanation of each drawing is omitted.

The live streaming system 1 according to some embodiments of subject application provides enhancement among the users to communicate and interact smoothly. More specifically, it entertains the viewers and streamers in a technical way.

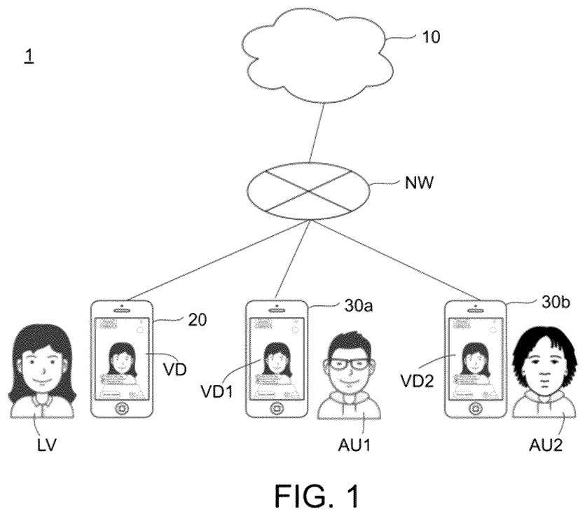

FIG. 1 shows a schematic configuration of a live streaming system 1 according to some embodiments of subject application. The live streaming system 1 provides a live streaming service for the streaming streamer (may also be referred as live or streamer) LV and viewer (may also be referred as audience) AU (AU1, AU2 . . . ) to interact mutually in real time. As shown in FIG. 1, the live streaming system 1 may include a server 10, a user terminal 20 and a user terminal 30(30a, 30b . . . ). The user terminal 20 may be a streamer and the user terminal 30 may be a viewer. In some embodiments, the streamers and viewers may be referred to as the user. The server 10 may include one or a plurality of information processing devices connected via network NW. The user terminal 20 and 30 may be, for example, a portable terminal such as the smartphone, tablet, laptop PC, recorder, mobile game console, wearable device or the like, or the stationary computer such as desktop PC. The server 10, user terminal 20 and user terminal 30 may be communicably connected by any type of wire or wireless network NW.

The live streaming system 1 is involved in the streamer LV, the viewer AU, and APP provider (not shown), who provides the server 10. The streamer LV may record his/her own contents such as songs, talks, performance, game streaming or the like by his/her own user terminal 20 and upload to the server 10 and be the one who distributes contents in real time. In some embodiments, the streamer LV may interact with the viewer AU via the live streaming.

The APP provider may provide a platform for the contents to go on live streaming in the server 10. In some embodiments, the APP provider may be the media or manager to manage the real time communication between the streamer LV and viewer AU. The viewer AU may access the platform by the user terminal 30 to select and watch the contents he/she would like to watch. The viewer AU may perform operations to interact with the streamer, such as commenting or cheering the streamer, by the user terminal 30. The streamer, who provides the contents, may respond to the comment or cheer. The response of the streamer may be transmitted to the viewer AU by video and/or audio or the like. Therefore, a mutual communication among the streamer and viewer may be accomplished.

The “live streaming” in this specification may be referred to as the data transmission which enables the contents the streamer LV recorded by the user terminal 20 to be substantially reproduced and watched by the viewer AU via the user terminal 30, In some embodiments, the “live streaming” may also refer to the streaming which is accomplished by the above data transmission. The live streaming may be accomplished by the well-known live streaming technology such as HTTP Live Streaming, Common Media Application Format, Web Real-Time Communications, Real-Time Messaging Protocol, MPEG DASH or the like. The live streaming may further include the embodiment that the viewer AU may reproduce or watch the contents with specific delay while the streamer is recording the contents. Regarding the magnitude of the delay, it should be at least small enough to enable the streamer LV and the viewer AU to communicate. However, live streaming is different from so-called on-demand streaming. More specifically, the on-demand streaming may be referred to as storing all data, which records the contents, in the server and then providing the data from the server to the user at random timing according to the user's request.

The “streaming data” in this specification may be referred to as the data includes image data or voice data. More specifically, the image data (may be referred to as video data) may be generated by the image pickup feature of the user terminal 20 and 30. The voice data (may be referred to as audio data) may be generated by the audio input feature of the user terminal 20 and 30. The streaming data may be reproduced by the user terminal 20 30, so that the contents relating to users may be available for watching. In some embodiments, during the period from the streaming data being generated by the user terminal of the streamer to being reproduced by the user terminal of the viewer, the processing of changing format, size or specification of the data, such as compression, extension, encoding, decoding, transcoding or the like, is predictable. Before and after this kind of processing, the contents (such as video and audio) are substantially unchanged, so it is described in the current embodiments of the present disclosure that the streaming data before being processed is the same as that after being processed. In other words, if the streaming data is generated by the user terminal of the streamer and reproduced by the user terminal of the viewer via the server 10, the streaming data generated by the user terminal of the streamer, the streaming data passed through the server 10 and the streaming data received and reproduced by the by the user terminal of the viewer are all the same streaming data.

As shown in FIG. 1, the streamer LV is providing the live streaming. The user terminal 20 of the streamer generates the streaming data by recording his/her video and/or audio, and transmits to the server 10 via the network NW. At the same time, the user terminal 20 may display the video VD on the display of the user terminal 20 to check the streaming contents of the streamer LV.

The viewer AU1, AU2 of the user terminal 30a, 30b, who request the platform to provide the live streaming of the streamer, may receive streaming data corresponding to the live streaming via the network NW and reproduce the received streaming data to display the video VD1, VD2 on the display and output the audio from a speaker or the like. The video VD1, VD2 displayed on the user terminal 30a, 30b respectively may be substantially the same as the video VD recorded by the user terminal of the streamer LV, and the audio outputted from the terminal 30a, 30b may also be substantially the same as the audio recorded by the user terminal of the streamer LV.

The recording at the user terminal 20 of the streamer may be simultaneous with the reproducing of the streaming data at the user terminal 30a, 30b of the viewer AU1, AU2. If a viewer AU1 inputs a comment on the contents of the streamer LV into the user terminal 30a, the server 10 will display the comment on the user terminal 20 of the streamer in real time, and also display on the user terminal 30a, 30b of the viewer AU1, AU2 respectively. If the streamer LV responds to the comment, the response may be outputted as the text, image, video or audio from the terminal 30a, 30b of the viewer AU1, AU2, so that the communication of the streamer LV and viewer LV may be realized. Therefore, the live streaming system may realize the live streaming of two-way communication.

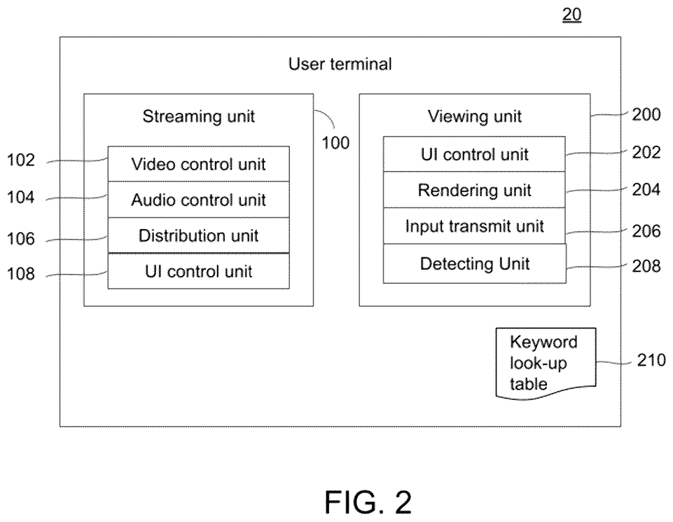

FIG. 2 is a block diagram showing a function and configuration of the user terminal 20 in FIG. 1 according to the embodiment of the present disclosure. The user terminal 30 has the similar function and configuration of the user terminal 20. The blocks depicted in the block diagram of this specification are implemented in hardware such as devices like a CPU of a computer or mechanical components, and in software such as a computer program depicts functional blocks implemented by the cooperation of these elements. Therefore, it will be understood by those skilled in the art that the functional blocks may be implemented in a variety of manners by a combination of hardware and software.

The streamer LV and viewer AU may download and install the live streaming application (live streaming APP) of the present disclosure to the user terminal 20 and 30 from the download site via network NW. Or the live streaming APP may be pre-installed in the user terminal 20 and 30. By the execution of the live streaming by the user terminal 20 and 30, the user terminals 20 and 30 may communicate with the server 10 via the network NW to realize a plurality of functions. The functions realized by the execution of the live streaming APP by the user terminal 20 and 30 (More specifically, the processor such as CPU) is described below as the functions of the user terminal 20 and 30. These functions are basically the functions that the live streaming APP makes the user terminals 20 and 30 realize. In some embodiments, these functions may also be realized by transmitting from the server 10 to the web browser of the user terminal 20 and 30 via network NW and be executed by the computer program of the web browser. The computer program may be written in the programming language such as HTML (Hyper Text Markup Language) or the like.

The user terminal 20 includes streaming unit 100 and viewing unit 200. In some embodiments, the streaming unit 100 is configured to record the audio and/or video data of the user and generate streaming data to transmit to the server 10. The viewing unit 200 is configured to receive and reproduce streaming data from server 10. In some embodiments, a user may activate the streaming unit 100 when broadcasting or activate the viewing unit 200 when watching streaming respectively. In some embodiments, the user terminal who is activating the streaming unit 100 may be referred to as an streamer or be referred to as the user terminal which generates the streaming data. The user terminal who is activating the viewing unit 200 may be referred to as an viewer or be referred to as the user terminal which reproduces the streaming data.

The streaming unit 100 may include video control unit 102, audio control unit 104, distribution unit 106 and UI control unit 108. The video control unit 102 may be connected to a camera (not shown) and the video is controlled by the camera. The video control unit 102 may obtain the video data from the camera. The audio control unit 104 may be connected to a microphone (not shown) and the audio is controlled by the microphone. The audio control unit 104 may obtain the audio data from the microphone.

The distribution unit 106 receives streaming data, which includes video data from the video control unit 102 and audio data from the audio control unit 104, and transmits to the server 10 via network NW. In some embodiments, the distribution unit 106 transmits the streaming data in real-time. In other words, the generation of the streaming data from the video control unit 102 and audio control unit 104, and the distribution of the distribution unit 106 is performed simultaneously.

UI control unit 108 controls the UI for the streamer. The UI control unit 108 is connected to a display (not shown) and is configured to generate the streaming data to whom the distribution unit 106 transmits, reproduces and displays the streaming data on the display. The UI control unit 108 shows the object for operating or the object for instruction-receiving on the display and is configured to receive the tap input from the streamer.

The viewing unit 200 may include UI control unit 202, rendering unit 204, input transmit unit 206 and detecting unit 208. The viewing unit 200 is configured to receive streaming data from server 10 via network NW. The UI control unit 202 controls the UI for the viewer. The UI control unit 202 is connected to a display (not shown) and/or speaker (not shown) and is configured to display the video on the display and output the audio from the speaker by reproducing the streaming data. In some embodiments, Outputting the video on the display and audio from the speaker may be referred to as “reproducing the streaming data”. The UI control unit 202 may be connected to an input unit such as touch panel, keyboard or display or the like to obtain input from the users.

The rendering unit 204 may be configured to render the streaming data from the server 10 and the frame image. The frame image may include user interface objects for receiving input from the user, the comments inputted by the viewers and the data received from the server 10. The input transmit unit 206 is configured to receive the user input from the UI control unit 202 and transmit to the server 10 via the network NW.

In some embodiments, the user input may be clicking an object on the screen of the user terminal such as selecting a live stream, entering a comment, sending a gift, following or unfollowing an user, voting in an event, gaming generating an object or the like. For example, the input transmit unit 206 may generate gift information and transmit to server 10 via the internet NW if the user terminal of the viewer clicks a gift object on the screen in order to send a gift to the streamer.

In some embodiments, the streamer user terminal may generate an object and display the object on the screen. More specifically, the streamer may click an icon on the screen and a list of objects may be displayed. The streamer may select an object to be displayed and the object may be rendered on the streamer user terminal. The streamer may perform an operation on the object such as editing, moving deleting resizing or adjusting the attribute of the object or the like. In some embodiments, the object may include information such as frame portion, text portion or the like. At the same time, the information of the object may be transmitted to the viewer user terminal via the server 10. The object may also be rendered and displayed on the viewer user terminal. Therefore, the viewer may also see the information of the object from the streamer, and the interaction between the streamer and viewers may be improved.

The object may be a sticker, message, comment, decoration, text, image, emoji, animation or the like. In some embodiments, the object may include a text and the text is editable or amendable by the streamer user terminal. The streamer may enter text to show the information to the viewers in the live streaming room. For example, the streamer may enter “today is my birthday”, so that the viewer may know and say happy birthday to the streamer. The object may also include information such as “please follow me”, “please join my army”, “please protect me” or the like. In some embodiments, the text may include characters, letters, symbols, emoji or the like. In some embodiments, the object may include a frame portion to contain or decorate the text. In some embodiments, the location and number of objects may be determined by the streamer flexibly.

In some embodiments, the location of the object may be determined by the streamer. Once the object is generated on the screen, the location of the object may be random or in a specific region. In some embodiments, the location of the object may not be changed and the object may be still on the screen. The streamer may determine the location of the object by dragging the object to a specific location. According to the embodiments, the streamer may determine the location of the object flexibly. In some embodiments, the location of the object may also be changed dynamically. For example, the object may be rotated around a circle. The object may slide from left to right on the screen such as a marquee. Moreover, the object may also move according to the image of the streamer or the like. For example, the head of the streamer may be detected and the object may be attached and moved with the head of the streamer. According to the embodiments, the layout of the stickers may be diversified and the user experience may be improved. Moreover, the viewer may trace the movement of the sticker in order to click the sticker and may be like an interaction game between the streamer and viewers.

In some embodiments, the object may include a specific function according to the text and the function may be triggered in response to an operation performed by the viewer user terminal. For example, if the text includes an event-related keyword, then the event gift list page may be opened when the viewer user terminal clicks on the object. According to the embodiments, the streamer may create his or her own stickers for the viewer to click, so the interaction among the streamer and viewers may be improved.

The detecting unit 208 may be configured to detect input from the user terminal. In some embodiments, the detecting unit 208 may detect text in the object and trigger a corresponding function if specific keywords are detected. For example, if the keyword of “gift” is detected, the gift list page may be shown. If the streamer is participating in an event and needs the event gift from the viewers, the streamer may enter “please help me with the event” in the text. If the viewer clicks the object, the detecting unit 208 may detect the keyword of “event” and open the event gift list page for the viewer. According to the embodiments, the viewers may understand the need of the streamer easily and help the streamer more quickly. Therefore, the interaction among the streamer and viewers may be improved.

In some embodiments, the detecting unit 208 may also detect different kinds of input from the user terminal and generate an object according to the input. For example, the detecting unit 208 may generate an object according to the operation from the user terminal. The streamer may click the object function and edit text in the object In some embodiments, the detecting unit 208 may show some template objects for the user terminal to generate the object more quickly. The template object may be the object the user streamer generated recently, the object the user terminal generated in advance, the most popular object, the recommended object or the like. In some embodiments, the recommended object may be changed according to the text the user terminal entered. For example, if the streamer enters “join”, “join army” object may be recommended. If the streamer entered “gua”, then the “guard me” object may be recommended. In some embodiments, a machine learning model may be introduced to predict the object the viewer would like to generate according to the input from the viewer.

The detecting unit 208 may also detect audio input from the user terminal and generate an object according to the audio input. For example, the streamer may say “I would like to generate an army sticker”, and the detecting unit 208 may generate the army sticker accordingly. The detecting unit 208 may also detect image or video input from the user terminal and generate an object according to the image or video input The image or video input may be the facial feature or gesture or the like, and the facial feature or gesture recognition technology may be introduced and applied. If the streamer has a specific facial feature or gesture, the detecting unit 208 may generate a sticker for the streamer. In some embodiment, the specific audio, image or video input may be determined in real time or in advance. In some embodiments, the specific audio, image or video input may also be determined by the streamer, viewer, APP provider or the like flexibly.

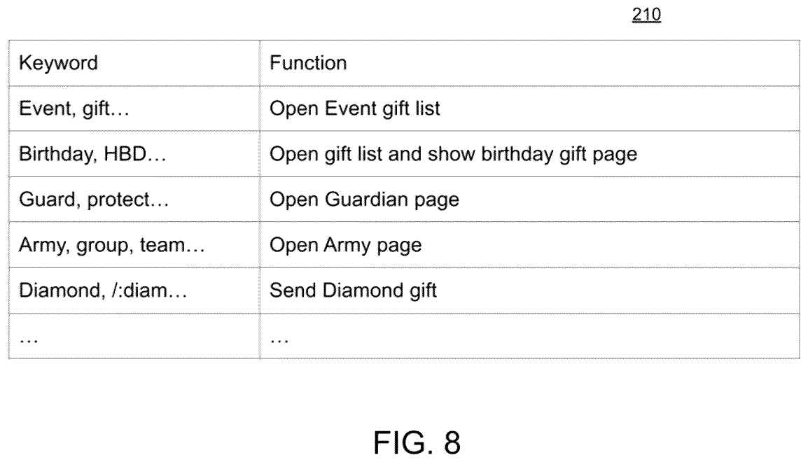

In some embodiments, the user terminal 20 may include a keyword look-up table 210 as shown in FIG. 2. The keyword look-up table 210 may be configured to store the information of the keyword and the corresponding function. FIG. 8 shows an exemplary data structure of the keyword look-up table 210 of FIG. 2. The keyword look-up table 210 holds information about the keyword and corresponding function. The keyword look-up table 210 stores a keyword for identifying a specific text the user terminal entered, and a corresponding function for identifying the function triggered by the keyword.

In some embodiments, the function may be changed according to the keyword in the object As shown in FIG. 8, if the text in the object includes event, gift or the like, the object may access the viewer to the event gift list page. If the text includes birthday, HBD or the like, the gift list page may be opened and stopped at the birthday gift page. If the text includes subscription-related keywords such as guard, arm or the like, a corresponding guardian page, army page or the like may be open. In some embodiments, the object may also be an hyperlink for a specific gift if a keyword related to a specific gift is included. For example, if there is a diamond gift and the text includes a diamond, the object may also be the diamond gift object. According to the embodiments, the streamer may provide suitable objects for the viewers and the interaction among streamer and viewers may be improved.

In some embodiments, the streamer may generate the object for the viewers. In some embodiments, the streamer may generate the object for himself or herself. For example, the streamer may generate an object with a specific keyword for opening the viewer list page, so that the streamer may easily open the viewer list page by clicking on the object. In some embodiments, the viewers may generate the object for the streamer. For example, the viewer may generate an object with keywords for the streamer to poke everyone in the streaming room, so that the streamer may click on the object to poke everyone. Here, the poke function may be referred to as a function for the streamer to cue the viewer to interact with the streamer such as poking the viewer to catch their attention. In some embodiments, the viewers may generate the object for themself. In some embodiments, the authority for generating an object from the viewer may be determined by the attribute of the viewer such as level, membership or the like. In some embodiments, the server 10 may also generate the object for the streamers and/or the viewers flexibly. In some embodiments, the object may be shown on both streamer user terminal and viewer user terminal, or only be shown in specific user terminal. In some embodiments, the mechanism of the object may be designed flexibly.

The keyword and function may be determined by the server 10, by the streamer user terminal, or by the viewer user terminal or the like. In some embodiments, the keyword look-up table may be updated in real time or in advance. The keyword look-up table may also be modified or updated by machine learning technology. The machine learning model may be introduced to predict the keyword and the corresponding function. In some embodiments, the keyword look-up table may be determined flexibly.

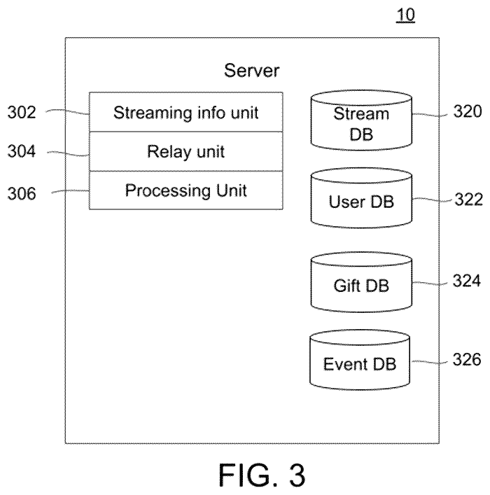

FIG. 3 is a schematic block diagram of the server 10 according to some embodiments of the subject application. The server 10 may include streaming info unit 302, relay unit 304, processing unit 306, stream DB 320, user DB 322, gift DB 324, event DB 326.

The streaming info unit 302 receives the request of live streaming from the user terminal 20 of the streamer via the network NW. Once receiving the request, the streaming info unit 302 registers the information of the live streaming on the stream DB 320. In some embodiments, the information of the live streaming may be the stream ID of the live streaming and/or the streamer ID of the streamer corresponding to the live streaming.

Once receiving the request of providing the information of the live streaming from the viewing unit 200 of the user terminal 30 from the viewer via the network NW, the streaming info unit 302 refers to the stream DB 320 and generates a list of the available live streaming.

The streaming info unit 302 then transmits the list to the user terminal 30 via the network NW. The UI control unit 202 of the user terminal 30 generates a live streaming selection screen according to the list and displays the list on the display of the user terminal 30.

Once the input transmit unit 206 of the user terminal 30 receives the selection of the live streaming from the viewer on the live streaming selection screen, it generates the streaming request including the stream ID of the selected live streaming and transmits to the server 10 via the network. The streaming info unit 302 may start to provide the live streaming, which is specified by the stream ID in the streaming request, to the user terminal 30. The streaming info unit 302 may update the stream DB 320 to add the viewer's viewer ID of the user terminal 30 to the streamer ID of the stream ID.

The relay unit 304 may relay the transmission of the live streaming from the user terminal 20 of the streamer to the user terminal 30 of the viewer in the live streaming started by the streaming info unit 302. The relay unit 304 may receive the signal, which indicates the user input from the viewer, from the input transmit unit 206 while the streaming data is reproducing. The signal indicating the user input may be the object-designated signal which indicates the designation of the object shown on the display of the user terminal 30. The object-designated signal may include the viewer ID of the viewer, the streamer ID of the streamer, who delivers the live streaming the viewer is viewing, and object ID specified by the object. If the object is a gift or the like, the object ID may be the gift ID or the like. Similarly, the relay unit 304 may receive the signal indicating the user input of the streamer, for example the object-designated signal, from the streaming unit 100 of the user terminal 20 while the streaming data is reproducing.

The processing unit 306 may be configured to process the information of the object in a live streaming room. The processing unit 306 receives information about the object from the streamer user terminal. The information of the object may include information in the object. For example, if the object is a sticker, the information of the object may include the frame portion and text portion. The processing unit 306 may store the information in a corresponding database. For example, the processing unit 306 may store the information of sticker ID and sticker info in the stream DB. The processing unit 306 may further transmit the information of the object to the viewer user terminal in the live streaming room. Therefore, the viewer user terminal may render the information of the object on the screen so that the viewer may be able to see the object.

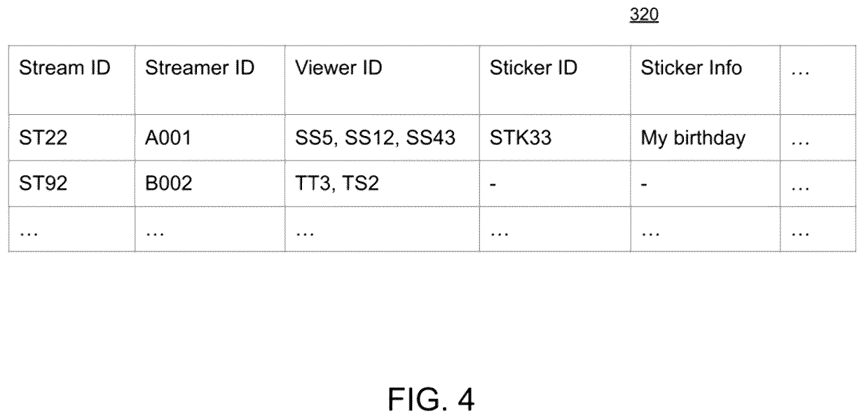

FIG. 4 shows an exemplary data structure of the stream DB 320 of FIG. 3. The stream DB 320 holds information regarding a live streaming currently taking place. The stream DB 320 stores a stream ID for identifying a live streaming on a live distribution platform provided by the live streaming system 1, a streamer ID for identifying the streamer who provides the live streaming a viewer ID for identifying viewers of the live streaming, a sticker ID for identifying the sticker of the live streaming, and a sticker info for identifying the information of the sticker, in association with each other. In some embodiments, each live streaming may include one or more than one sticker, or include no sticker.

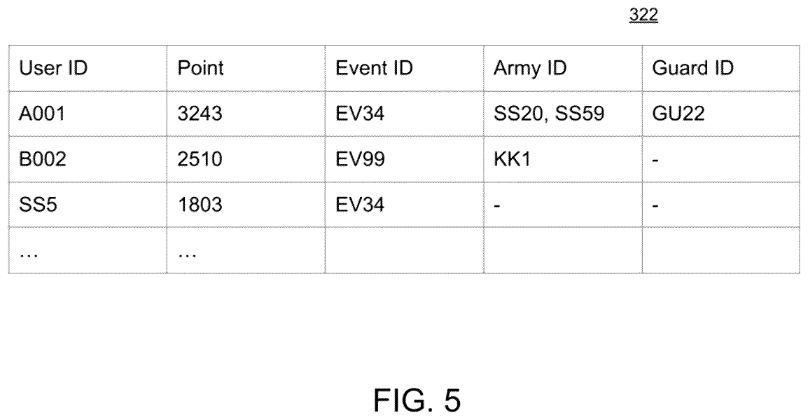

FIG. 5 shows an exemplary data structure of the user DB 322 of FIG. 3. The user DB 322 holds information regarding users. The user DB 322 stores a user ID for identifying a user, points that the user has, in association with each other. The point is the electronic value circulated within the live streaming platform. When a streamer receives a gift from a viewer during a live streaming, the streamer's points increase by the value of the gift. The points are used, for example, to determine the amount of reward or money the streamer receives from the administrator of the live streaming platform.

In some embodiments, the user DB 322 may maintain information on fan armies of various streamers. The user DB 322 maintains information by associating a user ID of the user and an army ID which is the user ID of a user who is the army of the corresponding user. An army of a user (hereinafter referred to as “marshal user”) is a user who subscribes to a subscription service of a marshal user, and can be said to be a member of the fan club of that marshal user. When the user is a member of the army, the user must pay a predetermined registration fee to the administrator on a regular basis (monthly or quarterly). The administrator grants at least a portion of that registration fee to the marshal user. If the viewer is in the army of the marshal user, he/she will receive a special gift, a special entry animation, and other benefits when watching a live streaming in which the marshal user is the streamer. Concerning the army, such a function can be realized by using the technology disclosed in “Rule for Army” 17LIVE, URL: https://17.live/en/army/about.

In some embodiments, the user DB 322 may maintain information on the guardian of the user. The user DB 322 maintains information by associating a user ID of the user and an guard ID which is the user ID of another user who the user is guarding. A guardian of a user (hereinafter referred to as “streamer”) is a user who subscribes to a subscription service of the streamer, and can be said to be a guardian of the streamer. The users may bid on the guardian of a streamer and the one who bid the highest may win the title of guardian of the streamer. Only one user may be the guardian of the streamer at the same time. In other words, if one user bids on the guardian of a streamer, then the user may be the guardian of the streamer. If another user sneaks in and bids higher points, then another user may take away the guardian from the current user. If the user is a guardian of the streamer, he/she will receive a special message frame, a special badge, a special entry animation, and other benefits when watching a live streaming of the streamer. Concerning the guardian, such a function can be realized by using the technology disclosed in “Guardian” 17LIVE, URL: https://17live-jp.zendesk.com/hc/ja/articles/4404313415055-% E3%82% AC % E3%83% BC % E3%83%87% E3%82% A3% E3%82% A2% E3%83% B3.

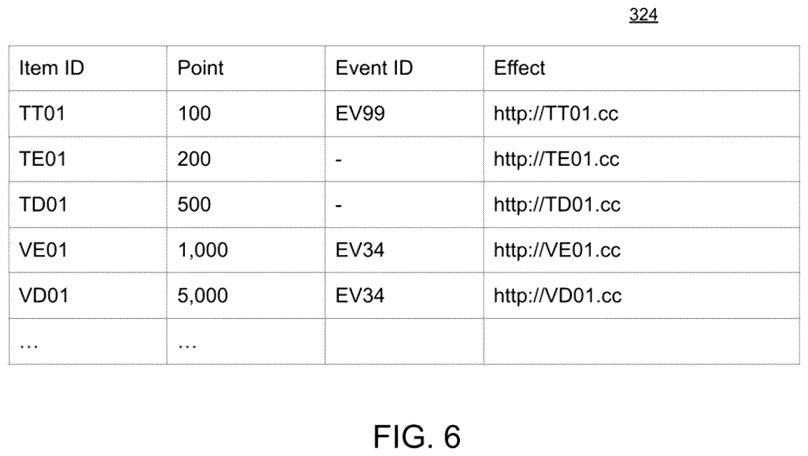

FIG. 6 shows an exemplary data structure of the gift DB 324 of FIG. 3. The gift DB 324 maintains information on gifts that can be used by the viewer in the live streaming. The gift DB 324 stores a gift ID for identifying a gift, the amount of points that the viewer spends in order to send the gift to the streamer, the event ID for identifying the event the gift is corresponding to, and the effect data for the gift, in association with each other.

The viewer can give the gift to the streamer by paying the equivalent value points for a desired gift while watching the live streaming. The payment of such equivalent value points can be made by an appropriate electronic means, for example, the viewer can pay the equivalent value points to the administrator. Alternatively, bank transfers or credit card payments can also be used. The relationship between awarded points and equivalent value points can be set arbitrarily by the administrator.

A gift is electronic data with the following characteristics:
It can be purchased in exchange for the points (later described in detail) or can be given for free.
It can be given by a viewer to a streamer.—Giving a gift to a streamer is referred to as using the gift or throwing the gift.
Some gifts may be purchased and used at the same time, and some gifts may be purchased or given and then used at any time later by the purchaser or recipient viewer.
When a viewer gives a gift to a streamer, the streamer is awarded the amount of points corresponding to the gift and an effect associated with the gift is exerted. For example, an effect corresponding to the gift will appear on the live streaming screen.

The effect is a visual or auditory or tactile effect (e.g., vibration) or a combination thereof that characterizes a gift. Examples of the visual effect include animation, images, and flashing/blinking. Examples of the auditory effect include sound effects and voice. The effect data is data for realizing such an effect on the user terminal 20, and the user terminal 20 realizes such an effect by processing the effect data. Since the technique for realizing the effect data itself is known, it will not be hereunder described in detail.

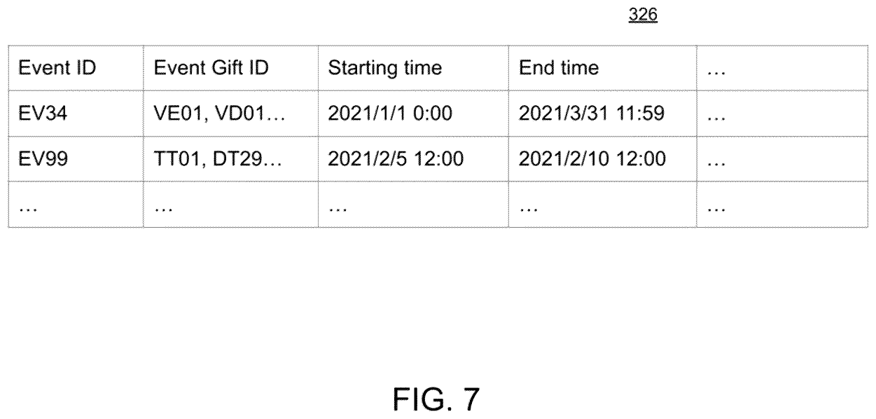

FIG. 7 shows an exemplary data structure of the event DB 324 of FIG. 3. The event DB 324 stores the information of the event the APP or platform provider is holding. The event DB 324 stores an event ID for identifying an event, the event gift ID for identifying the gift in an event, the starting time and end time for identifying the starting time and end time of the event.

Here, the “event” may be referred to as the event for the streamer to compete with the points they received. The event may be held by the APP or platform provider. The viewers may send virtual items such as gifts to the streamers and each virtual item may be corresponding to a specific amount of points. The streamers may interact with the viewers to collect points. In the event, the streamers may be ranked according to the points they received. The streamers who received relatively high points may obtain the reward. In some embodiments, each event may include specific gifts respectively, so only specific gifts may contribute to the points the streamer received. In some embodiments, the gifts may be common to all the events. In some embodiments, the rule for the event may be designed according to the practical need.

The event may be started from the starting time and ended until the end time. The streamers who are participating in the event may compete with each other for the amount of event gift collected from the viewers during a specific time, which may be the period from the starting time to the end time. The streamer who collects the most amount of event gift may be the winner and receive a specific reward. In some embodiments, the rule of the event and the index for determining the winner may be designed flexibly.

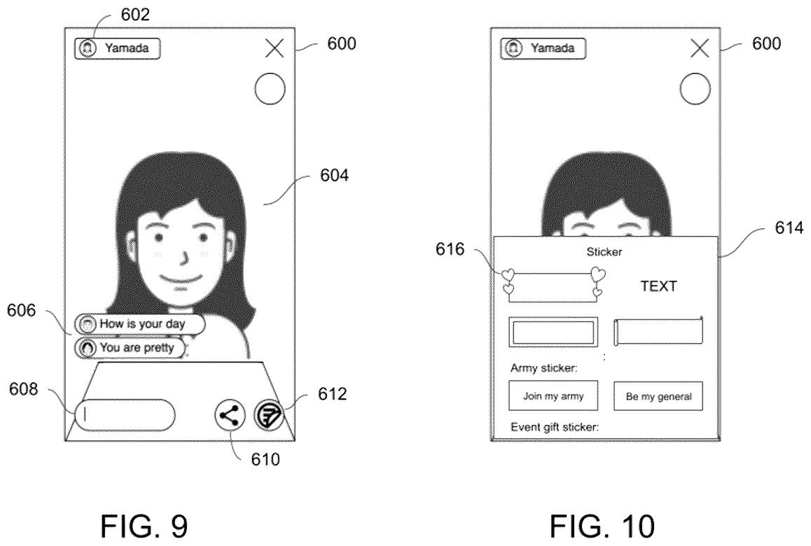

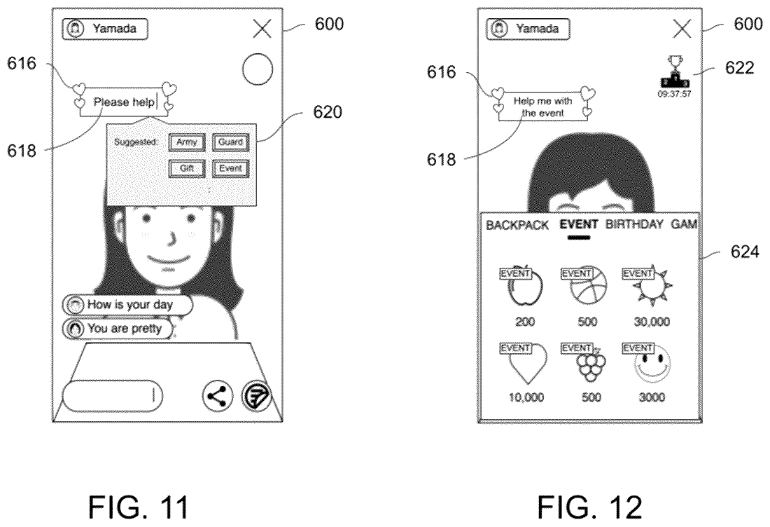

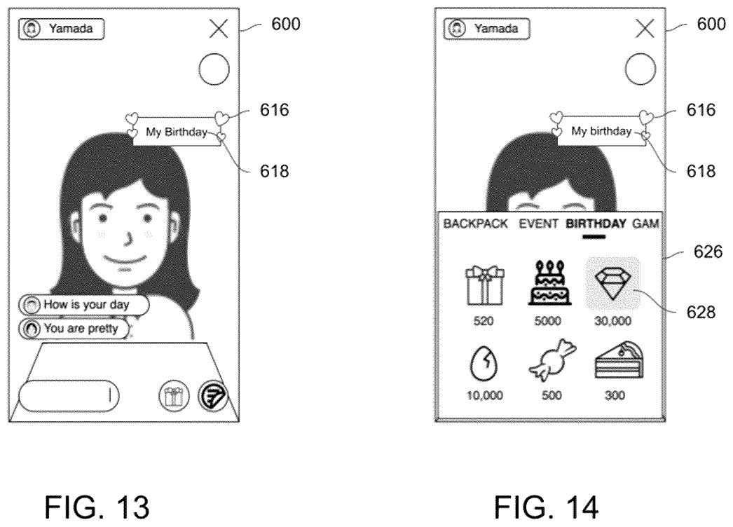

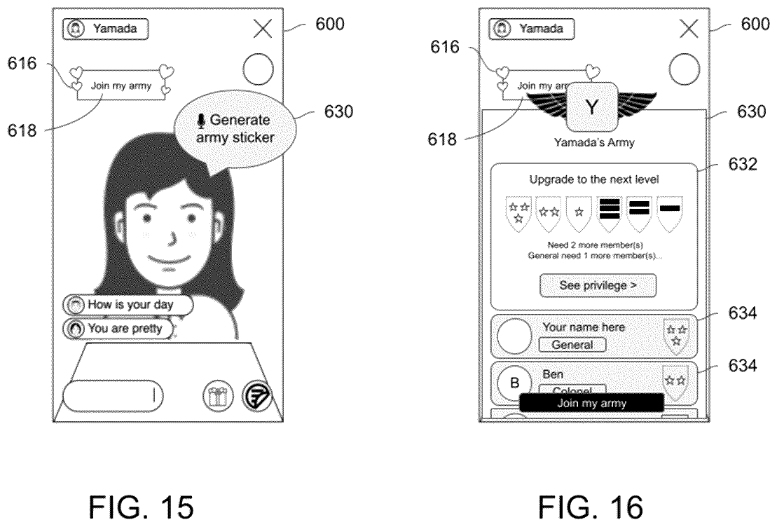

FIG. 9—FIG. 18 are exemplary screen images of a live streaming room screen 600 shown on the display of the streamer user terminal 20 or the viewer user terminal 30.

FIG. 9 is an exemplary screen image of a live streaming room screen 600 shown on the display of the streamer user terminal 20. Once the streamer finishes the setting of the live streaming and starts a live streaming room, a live streaming room screen 600 of the streamer may be shown on the display of the streamer user terminal.

In some embodiments, the live streaming room screen 600 includes a streamer info icon 602, streamer image zone 604, message zone 606, message input zone 608, function object 610 and sticker object 612. The streamer info icon 602 shows the information of the streamer. The streamer image zone 604 shows the image or video of the streamer and the image may be obtained by reproducing the video data. The message zone 606 shows the messages from the viewer, streamer or the server 10. The message input zone 608 shows an input zone for the streamer to enter a message or the like. The function object 610 provides the streamer with specific functions such as sharing, PK, streaming setting or the like. The function in the function object 610 may be designed flexibly. The sticker object 612 provides the streamer with the function of generating an object such as sticker or the like on the screen 600.

In some embodiments, if the streamer clicks on the sticker object 612, a sticker page may be shown on the screen 600. FIG. 10 is an exemplary screen image of a live streaming room screen 600 shown on the display of the streamer user terminal 20. As shown in FIG. 10, a sticker page 614 may be shown on the screen 600. In some embodiments, available stickers 616 may be displayed on the sticker page 614. The stickers 616 may include a plurality of frames for the streamer to select. The streamer may select a suitable frame and then edit text in the frame. In some embodiments, the stickers 616 may include text without a frame. In some embodiments, stickers 616 may include template stickers with specific text such as “join my army”, “send my event gift” or the like. In some embodiments, the stickers 616 may also include the historical stickers the streamer generated before. According to the embodiments, the streamer may quickly generate a sticker and the user experience may be improved.

Once the streamer selects a sticker 616, the sticker 616 may be displayed on the screen 600. FIG. 11 is an exemplary screen image of a live streaming room screen 600 shown on the display of the streamer user terminal 20. As shown in FIG. 11, a blank sticker 616 with frame is shown on the screen 600. The sticker may be editable. In other words, the streamer may click on the sticker 616 to edit the text 618 in the sticker 616. In some embodiments, a sticker generation helper 620 may be shown when the sticker is being edited. The sticker generation helper 620 may include suggested stickers such as template stickers, historical stickers, popular stickers or the like. The sticker generation helper 620 may also show suggested stickers according to the typing of the streamer. For example, the army sticker may be shown if the streamer enters “arm” or the like. In some embodiments, machine learning technology may be introduced to predict and recommend the user the suitable stickers.

FIG. 12 is an exemplary screen image of a live streaming room screen 600 shown on the display of the viewer user terminal 30. The viewer user terminal may include a similar user interface with the streamer user terminal. The viewer user terminal may receive the information of the sticker from the streamer user terminal via the server 10. The information of the sticker may be rendered and displayed on the screen 600 of the viewer user terminal. As shown in FIG. 12, the streamer may generate a sticker 616 and enter a text 618 of “help me with the event” or the like. The streamer may join an event to compete with the other streamers. In some embodiments, an event icon 622 may also be displayed on the screen 600 of the streamer and viewer user terminal to indicate that the streamer is involved in an event. If the streamer is participating in an event, the server 10 may generate the event icon automatically and transmit to the streamer and the viewers. The event icon 622 may be displayed on the streamer user terminal and viewer user terminal. In some embodiments, an event description page may be displayed if the streamer or the viewer click on the event icon 622. The event description may include the rules of the event or the like. In some embodiments, the event gift page may be displayed if the viewer clicks on the event icon 622. In some embodiments, the sticker 616 and the event icon 622 may trigger the same or different function from each other. For example, both may open an event gift page. One of them may open an event gift page and the other may open an event description page. According to the embodiment, it helps the viewer to send the event gift to the streamer in a more convenient manner and the user experience may be improved. Moreover, the sticker 616 may trigger the same, similar or different function to the icon generated by the server 10 on the screen 600. Therefore, the flexibility of the sticker 616 may be higher and the user experience may be improved.

In some embodiments, the streamer may generate the sticker 616 with text 618 of “help me with the event” to ask the viewer for the support in an event. The detecting unit 208 may detect the text 618 and look up in the keyword look-up table 210. If the detecting unit 208 detects that a function of “open event gift list” is corresponding to the keyword “event”, then the detecting unit 208 may open the event gift list for the viewer in response to an operation from the viewer such as clicking the sticker 616. As shown in FIG. 12, the event gift page 624 may be displayed if the viewer clicks on the sticker 616. According to the embodiments, the streamer may customize the information for the viewer and help the viewer to get access to the corresponding function quickly, and the user experience is improved.

FIGS. 13 and 14 are an exemplary screen image of a live streaming room screen 600 shown on the display of the viewer user terminal 30. In some embodiments, the streamer may generate a sticker 616 and enter a text 618 of “my birthday” or the like. The detecting unit 208 may detect the text 618 and look up in the keyword look-up table 210 to find out the function of “open birthday gift list”. As shown in FIG. 14, the birthday gift page 626 may be displayed if the viewer clicks on the sticker 616. In some embodiments, the sticker 616 may also be a specific gift item if a specific keyword is entered. For example, if the streamer would like to receive diamond gift 628 as shown in FIG. 14, the streamer may enter “send my diamond” or the like. The sticker 616 may become the icon for the specific gift item. In some embodiments, the sticker 616 with the text 618 may trigger any possible function in the live streaming room according to the keywords in the sticker 616.

FIGS. 15 and 16 are exemplary screen images of a live streaming room screen 600 shown on the display of the viewer user terminal 30. In some embodiments, the streamer may generate a sticker 616 by audio input such as microphone or the like. For example, the streamer may say “generate a sticker” or “army sticker” or the like, then the detecting unit 208 may detect the audio input 630 from the streamer and generate a corresponding sticker 616 with text 618 for the streamer. The streamer may also edit or change the text 618 in the sticker 616. In some embodiments, the sticker 616 may not be able to or may be able to be edited if the sticker 616 is a template sticker. In some embodiments, the streamer may allow or restrict the viewer to generate a sticker. In some embodiments, the viewer user terminal may pay a specific amount of points to generate a sticker for the streamer or the like. In some embodiments, the setting of the sticker may be designed flexibly. In some embodiments, a blank sticker may also be generated according to the audio or image input from the streamer or the like.

Similarly, an army page 630 may be displayed if the viewer clicks on the sticker 616. The army page 630 may include army description 632 and army status 634 or the like. The army description 632 may include information about the owner of the army, the hierarchy of the army, the privilege of the army or the like. The army status 634 may show the current user in the corresponding position. According to the embodiments, the viewer may know that the streamer would like to invite the viewer to join the army, and the viewer may access to the army page 630 via the sticker 616 in a more convenient manner. Therefore, the user experience may be improved.

FIGS. 17 and 18 are exemplary screen images of a live streaming room screen 600 shown on the display of the viewer user terminal 30. In some embodiments, the streamer may generate a sticker 616 by image input such as facial feature or gesture or the like. For example, the streamer may show the index finger and little finger and shake the hand, then the detecting unit 208 may detect the streamer image zone 604 and generate a corresponding sticker 616 with text 618 for the streamer. In some embodiments, the streamer may frown, grin or the like to indicate a generation of a specific sticker. In some embodiments, the audio input or the image input such as facial feature or gesture may be determined in advance or real-time. In other words, the APP or platform provider may set up a rule for how to generate stickers according to audio input or the image input. The user may also set up a customized rule for generating stickers by themself. In some embodiments, the generation of stickers may also be designed flexibly.

Similarly, a guardian page 636 may be displayed if the viewer clicks on the sticker 616. The guardian page 636 may include guardian description 638, guardian bidding info 640 or the like. The guardian description 638 may include information about the current guardian, the left time of the current guardian, the privilege of the guardian, the historical guardian or the like. In some embodiments, the description in the guardian description 638 may be designed flexibly. The guardian bidding info 640 may show the information of bidding on the guardian of the streamer. As described above, one streamer may have only one guardian at the same time, so the guardian may be determined by bidding on the guardian. The viewer may place a bid on the guardian bidding info 640 to request for the guardian of the streamer. According to the embodiments, the user experience may also be improved.

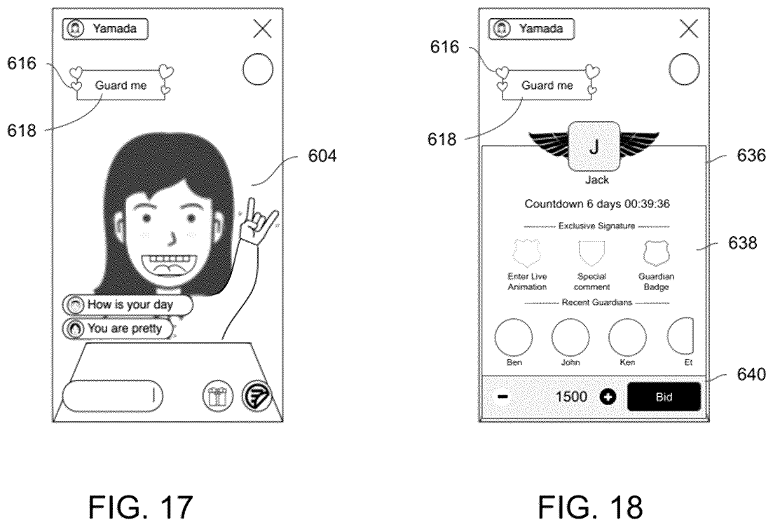

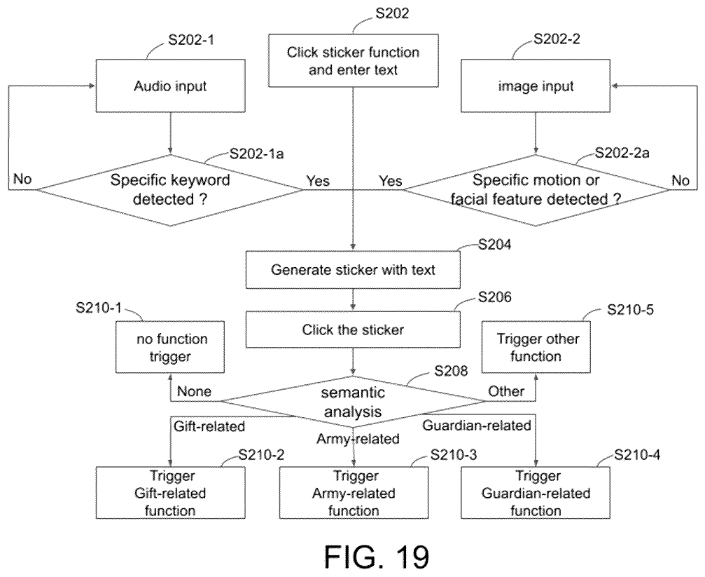

The operation of the live streaming system 1 with the above configuration will be now described. FIG. 19 is a flowchart showing steps of an application activation process on the user terminals 20 and 30. the streamer may generate an object such as a sticker in a plurality of ways. For example, the streamer may click the sticker function and enter text by his or her own (S202). Upon finishing the setting of the sticker, the sticker with text may be generated and displayed on the screen according to the operation of the streamer (S204).

In some embodiments, the streamer may also turn on the microphone and say specific keywords to generate stickers (S202-1). The detecting unit 208 may detect the audio input from the streamer (S202-1a). If the detecting unit 208 does not detect a specific keyword (No in S202-1a), the detecting unit 208 may keep receiving the audio input from the streamer(S202-1). If the specific keyword is detected (Yes in S202-1a), a corresponding sticker with text may be generated and displayed on the screen according to the operation of the streamer (S204).

In some embodiments, the streamer may also make a specific facial feature or gesture to generate stickers (S202-2). The detecting unit 208 may detect the image input from the streamer (S202-2a). If the detecting unit 208 does not detect a specific facial feature or gesture (No in S202-2a), the detecting unit 208 may keep receiving the image input from the streamer(S202-2). If the specific facial feature or gesture is detected (Yes in S202-2a), a corresponding sticker with text may be generated and displayed on the screen according to the operation of the streamer (S204).

Once the viewer performs an operation such as clicking the sticker (S206), the detecting unit 208 may perform an semantic analysis on the text of the sticker (S208). In some embodiments, the detecting unit 208 may perform the semantic analysis by a third-party service or a machine learning model. The detecting unit 208 may extract specific keywords from the text of the sticker and look up a corresponding function according to a keyword look-up table 210.

In some embodiments, the corresponding function may be triggered according to the operation from the viewer. For example, if no keyword is detected in the semantic analysis (None in S208), then no function may be triggered (S210-1). In some embodiments, if a gift-related keyword is detected in the semantic analysis (gift-related in S208), then the gift-related function may be triggered (S210-2). The gift-related function may be, for example, open an event gift list page or send specific gift or the like. In some embodiments, if an army-related keyword is detected in the semantic analysis (army-related in S208), then the army-related function may be triggered (S210-3). The army-related function may access the viewer to the subscription information of the streamer's army or the like. In some embodiments, if a guardian-related keyword is detected in the semantic analysis (guardian-related in S208), then the guardian-related function may be triggered (S210-4). The guardian-related function may access the viewer to the subscription information of the streamer's guardian or the like. In some embodiments, if other specific keywords are detected in the semantic analysis (guardian-related in S208), then the other function may be triggered (S210-5). The other function and keywords may be determined flexibly.

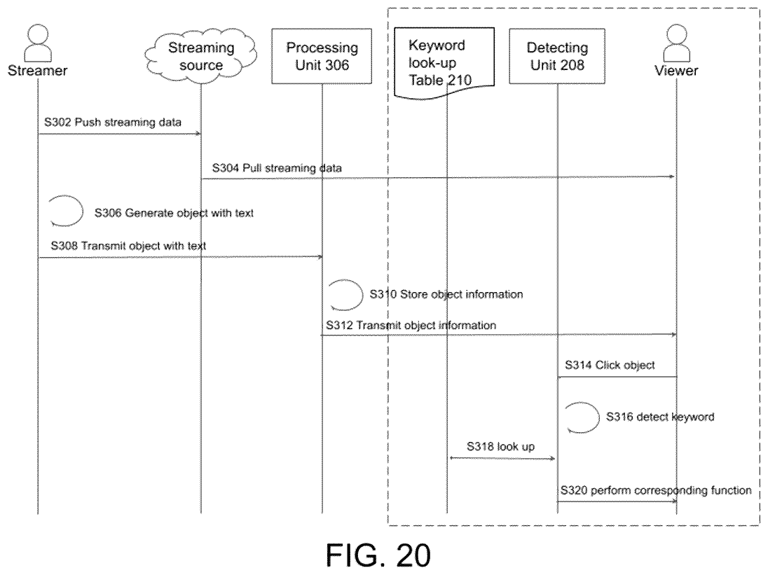

FIG. 20 is an exemplary sequence chart illustrating an operation of the configuration of the live streaming system 1 according to some embodiments of subject application. In some embodiments, a streamer may start a live streaming by pushing the streaming data to a streaming source (S302). Viewers may pull the streaming data by tapping on the streamer the viewer would like to watch (S304).

During the live streaming, the streamer and viewers may interact with each other by sending interaction information such as comments, gifts, animations or the like. In some embodiments, the streamer may also generate an object with text on the screen (S306). In some embodiments, the object may be a sticker for decoration and the text may be the information the streamer would like to show on the screen. The information of the object with text may be transmitted to the processing unit 306 in server 10 (S308). The processing unit 306 may store the information of the object in a corresponding database such as stream DB 320 or the like (S310). In some embodiments, the processing unit 306 may generate the sticker ID and store the sticker ID and sticker info in the stream DB 320. In some embodiments, the processing unit 306 may further transmit the sticker ID and related information to the streamer user terminal, so that the sticker may also be identified by the streamer user terminal. Moreover, the streamer may generate more than one sticker on the screen. If the streamer adds, deletes, and amends one of the stickers, the streamer user terminal may communicate with the server 10 according to the sticker ID. The processing unit 306 may transmit the information of the object to the viewer user terminals in the live streaming room (S312). In some embodiments, the streaming source may be a streaming server and the server 10 may be a backend server of an APP or platform provider.

The viewer user terminal may render the information of the object with the streaming data and display the live streaming room with the object on the screen. In some embodiments, the viewer may perform an operation on the object such as clicking the object (S314). The detecting unit 208 may detect the text in the object (S316). In some embodiments, the detecting unit 208 may look up the keyword look-up table 210 to check if any keywords are included in the text (S318). If the text includes a specific keyword and the keyword is corresponding to a function, the detecting unit 208 may perform the function in response to the operation of clicking on the sticker from the viewer user terminal.

In some embodiments, the detecting unit 208 and keyword look-up table 210 may be downloaded and installed in the user terminal in advance. In some embodiments, the detecting unit 208 and keyword look-up table 210 may also be provided in the server 10. More specifically, the server 10 may detect the keyword and trigger a specific function in response to the clicking on the sticker from the viewer user terminal. In other words, the detecting unit 208 and keyword look-up table 210 may be implemented in the server 10 or user terminal 20 or 30. In some embodiments, the configuration may be designed flexibly.

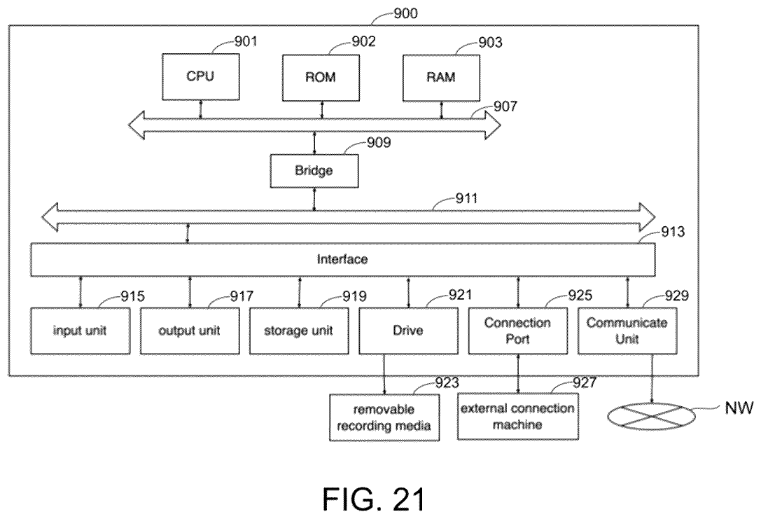

FIG. 21 is a schematic block diagram of computer hardware for carrying out a system configuration and processing according to some embodiments of subject application. The information processing device 900 in FIG. 21 is, for example, is configured to realize the server 10 and the user terminal 20, 30 respectively according to some embodiments of subject application.

The information processing device 900 includes a CPU 901, read only memory (ROM) 903, and random-access memory (RAM) 905. In addition, the information processing device 900 may include a host bus 907, a bridge 909, an external bus 911, an interface 913, an input unit 915, an output unit 917, a storage unit 919, a drive 921, a connection port 925, and a communication unit 929. The information processing device 900 may include imaging devices (not shown) such as cameras or the like. The information processing device 900 may include a processing circuit such as a digital signal processor (DSP) or an application-specific integrated circuit (ASIC), instead of or in addition to the CPU 901.

The CPU 901 functions as an arithmetic processing device and a control device, and controls the overall operation or a part of the operation of the information processing device 900 according to various programs recorded in the ROM 903, the RAM 905, the storage unit 919, or a removable recording medium 923. For example, the CPU 901 controls overall operations of respective function units included in the server 10 and the user terminal 20 and 30 of the above-described embodiment. The ROM 903 stores programs, operation parameters, and the like used by the CPU 901. The RAM 905 transiently stores programs used when the CPU 901 is executed, and parameters that change as appropriate when executing such programs. The CPU 901, the ROM 903, and the RAM 905 are connected with each other via the host bus 907 configured from an internal bus such as a CPU bus or the like. The host bus 907 is connected to the external bus 911 such as a Peripheral Component Interconnect/Interface (PCI) bus via the bridge 909.

The input unit 915 is a device operated by a user such as a mouse, a keyboard, a touchscreen, a button, a switch, and a lever. The input unit 915 may be a device that converts physical quantity to electrical signal such as audio sensor (such as microphone or the like), acceleration sensor, tilt sensor, infrared radiation sensor, depth sensor, temperature sensor, humidity sensor or the like. The input unit 915 may be a remote-control device that uses, for example, infrared radiation and another type of radio waves. Alternatively, the input unit 915 may be an external connection device 927 such as a mobile phone that corresponds to an operation of the information processing device 900. The input unit 915 includes an input control circuit that generates input signals on the basis of information which is input by a user to output the generated input signals to the CPU 901. The user inputs various types of data and indicates a processing operation to the information processing device 900 by operating the input unit 915.

The output unit 917 includes a device that can visually or audibly report acquired information to a user. The output unit 917 may be, for example, a display device such as an LCD, a PDP, and an OLED, an audio output device such as a speaker and a headphone, and a printer. The output unit 917 outputs a result obtained through a process performed by the information processing device 900, in the form of text or video such as an image, or sounds such as audio sounds.

The storage unit 919 is a device for data storage that is an example of a storage unit of the information processing device 900. The storage unit 919 includes, for example, a magnetic storage device such as a hard disk drive (HDD), a semiconductor storage device, an optical storage device, or a magneto-optical storage device. The storage unit 919 stores therein the programs and various data executed by the CPU 901, and various data acquired from an outside.

The drive 921 is a reader/writer for the removable recording medium 923 such as a magnetic disk, an optical disc, a magneto-optical disk, and a semiconductor memory, and built in or externally attached to the information processing device 900. The drive 921 reads out information recorded on the mounted removable recording medium 923, and outputs the information to the RAM 905. The drive 921 writes the record into the mounted removable recording medium 923.

The connection port 925 is a port used to directly connect devices to the information processing device 900. The connection port 925 may be a Universal Serial Bus (USB) port, an IEEE1394 port, or a Small Computer System Interface (SCSI) port, for example. The connection port 925 may also be an RS-232C port, an optical audio terminal, a High-Definition Multimedia Interface (HDMI (registered trademark)) port, and so on. The connection of the external connection device 927 to the connection port 925 makes it possible to exchange various kinds of data between the information processing device 900 and the external connection device 927.

The communication unit 929 is a communication interface including, for example, a communication device for connection to a communication network NW. The communication unit 929 may be, for example, a wired or wireless local area network (LAN), Bluetooth (registered trademark), or a communication card for a wireless USB (WUSB).

The communication unit 929 may also be, for example, a router for optical communication, a router for asymmetric digital subscriber line (ADSL), or a modem for various types of communication. For example, the communication unit 929 transmits and receives signals on the Internet or transmits signals to and receives signals from another communication device by using a predetermined protocol such as TCP/IP. The communication network NW to which the communication unit 929 connects is a network established through wired or wireless connection. The communication network NW is, for example, the Internet, a home LAN, infrared communication, radio wave communication, or satellite communication.

The imaging device (not shown) is a device that images real space using an imaging device such as a charge coupled device (CCD) or a complementary metal oxide semiconductor (CMOS), for example, and various members such as a lens for controlling image formation of a subject image on the imaging device and generates a captured image. The imaging device may capture a still picture or may capture a movie.

The present disclosure of the live streaming system 1 has been described with reference to embodiments. The above-described embodiments have been described merely for illustrative purposes. Rather, it can be readily conceived by those skilled in the art that various modifications may be made in making various combinations of the above-described components or processes of the embodiments, which are also encompassed in the technical scope of the present disclosure.

The procedures described herein, particularly flowchart or those described with a flowchart, are susceptible to omission of part of the steps constituting the procedure, adding steps not explicitly included in the steps constituting the procedure, and/or reordering the steps. The procedure subjected to such omission, addition, or reordering is also included in the scope of the present disclosure unless diverged from the purport of the present disclosure.

In some embodiments, at least a part of the functions performed by the server 10 may be performed by other than the server 10, for example, being performed by the user terminal 20 or 30. In some embodiments, at least a part of the functions performed by the user terminal 20 or 30 may be performed by other than the user terminal 20 or 30, for example, being performed by the server 10. In some embodiments, the rendering of the frame image may be performed by the user terminal of the viewer, the server, the user terminal of the streamer or the like.

Furthermore, the system and method described in the above embodiments may be provided with a computer-readable non-transitory storage device such as a solid-state memory device, an optical disk storage device, or a magnetic disk storage device, or a computer program product or the like. Alternatively, the programs may be downloaded from a server via the Internet.

Although technical content and features of the present disclosure are described above, a person having common knowledge in the technical field of the present disclosure may still make many variations and modifications without disobeying the teaching and disclosure of the present disclosure. Therefore, the scope of the present disclosure is not limited to the embodiments that are already disclosed but includes another variation and modification that do not disobey the present disclosure, and is the scope covered by the following patent application scope.

### LIST OF REFERENCE NUMBERS

| | | | |
|---|---|---|---|
| 1 | Live streaming system | 10 | Server |
| 20 | User terminal | 100 | Streaming unit |
| 102 | Video control unit | 104 | Audio control unit |
| 106 | Distribution unit | 108 | UI control unit |
| 200 | Viewing unit | 202 | UI control unit |
| 204 | Rendering unit | 206 | Input unit |
| 208 | Detecting unit | 210 | keyword look-up table |
| 30, 30a, 30b | User terminal | 302 | Streaming info unit |
| 304 | Relay unit | 306 | Processing Unit |
| 320 | Stream DB | 322 | User DB |
| 324 | Gift DB | 326 | Event DB |
| 600 | Screen | 602 | Streamer info icon |
| 604 | Streamer image zone | 606 | Message zone |
| 608 | Message input zone | 610 | Function object |
| 612 | sticker object | 614 | Sticker page |
| 616 | Sticker | 618 | Text |
| 620 | Sticker generation helper | 622 | Event icon |
| 624 | event gift page | 626 | Birthday gift page |
| 900 | Information processing device | 901 | CPU |
| 903 | ROM | 905 | RAM |
| 907 | Host bus | 909 | Bridge |
| 911 | External bus | 913 | Interface |
| 915 | Input unit | 917 | Output unit |
| 919 | Storage unit | 921 | Drive |
| 923 | Removable recording medium | 925 | Connection port |
| 927 | External connection device | 929 | Communication unit |
| LS | Live streaming | LV | Streamer |
| NW | Network | SP | Specific portion |
| AU1, AU2 | Viewer | | |
| S202-S210, S302-S320 | Step | | |
| VD, VD1, VD2 | Video | | |

What is claimed is:

1. A terminal, comprising one or a plurality of processors, wherein the one or plurality of processors execute a machine-readable instruction to perform:
receiving an object in a live streaming;
displaying the object on the terminal;
detecting a keyword in the object corresponding to a function in the live streaming; and
triggering the function in response to an operation on the object.

2. The terminal according to claim 1, wherein
the function is changed according to the keyword in the object.

3. The terminal according to claim 1, wherein
the keyword includes characters, letters, symbols, emoji or the like.

4. The terminal according to claim 1, wherein
the function is to access the terminal to a subscription service if the object includes subscription-related keywords; and
the subscription service is to subscribe to a membership of a streamer such as following, army, guardian or the like.

5. The terminal according to claim 1, wherein
the function is to access the terminal to an event gift page if the object includes event-related keywords.

6. The terminal according to claim 1, comprising:
receiving a second object with a second function in a live streaming; and
displaying the second object on the terminal; wherein
the object is received from a second terminal via a server;
the second object is received from the server; and
the function and the second function are the same as or different from each other.

7. A terminal, comprising one or a plurality of processors, wherein the one or plurality of processors execute a machine-readable instruction to perform:
generating an object in a live streaming; and
displaying the object on the terminal; wherein
the object includes a keyword corresponding to a function in the live streaming.

8. The terminal according to claim 7, wherein
the object is generated by one of the following methods: an operation from the terminal, audio detection, image detection or the like.

9. The terminal according to claim 7, wherein
the object is editable; and
suggested object is shown when the object is being edited.

10. A non-transitory computer-readable medium including program instructions, that when executed by one or more processors, cause the one or more processors to execute:
receiving an object in a live streaming;
displaying the object on the terminal;
detecting a keyword in the object corresponding to a function in the live streaming; and
triggering the function in response to an operation on the object.
